(19) United States
(12) Patent Application Publication
(10) Pub. No.: US 2025/0165856 A1
(43) Pub. Date: May 22, 2025

(54) DISTRIBUTED COMPUTATION OF MACHINE LEARNING MODEL PERFORMANCE METRICS

(71) Applicant: Oracle International Corporation, Redwood Shores, CA (US)

(72) Inventors: Amit Kumar Prajapati, Kolkata (IN); Furqan Abdul Samad Shaikh, Bengaluru (IN); Antariksha Bhaduri, Bengaluru (IN)

(73) Assignee: Oracle International Corporation, Redwood Shores, CA (US)

(21) Appl. No.: 18/517,783

(22) Filed: Nov. 22, 2023

(51) Int. Cl. G06N 20/00

(52) U.S. Cl. CPC G06N 20/00

(57) ABSTRACT

Techniques are described for determining at least one performance metric of a machine learning model. The techniques including, obtaining a dataset generated by at least using output of the machine learning model, partitioning the dataset into two or more partitions that include one or more elements from the dataset; and generating, for each respective partition, a respective first quantile sketch and a respective second quantile sketch based at least in part on each element in the respective partition. The techniques further including generating a first merged quantile sketch by merging each respective first quantile sketch, generating a second merged quantile sketch by merging each respective second quantile sketch, and determining the at least one performance metric of the machine learning model using the first merged quantile sketch and the second merged quantile sketch.

### BACKGROUND

Use of machine learning models is becoming more prevalent. This has resulted in an increased desire to efficiently evaluate the performance of trained machine learning models. It is important that the performance of machine learning models is evaluated so that it can be known whether the model is effective at generating predictions for a set of inputs. Further, evaluating the performance of machine learning models helps determine if the model should be further trained, trained differently, and how confident a user or system can be with the predictions generated by a machine learning model. Current techniques for evaluating machine learning model performance can require many computational resources and may require long run times.

### SUMMARY

The present disclosure relates to evaluating the performance of trained machine learning models. Embodiments described herein may include techniques for determining various performance metrics of trained machine learning models. Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure.

Techniques (e.g., systems, methods, computer-readable mediums) are described for determining at least one performance metric of a machine learning model. The techniques including, obtaining a dataset generated by at least using output of the machine learning model, partitioning the dataset into two or more partitions that include one or more elements from the dataset; and generating, for each respective partition, a respective first quantile sketch and a respective second quantile sketch based at least in part on each element in the respective partition. The techniques further including generating a first merged quantile sketch by merging each respective first quantile sketch, generating a second merged quantile sketch by merging each respective second quantile sketch, and determining the at least one performance metric of the machine learning model using the first merged quantile sketch and the second merged quantile sketch

The foregoing, together with other features and embodiments will become more apparent upon referring to the following specification, claims, and accompanying drawings.

### BRIEF DESCRIPTION OF THE DRAWINGS

FIG. 1 is a simplified flow diagram of how a performance evaluation system can be used with a trained machine learning model, according to an example embodiment.

FIG. 2 is a simplified block diagram of a performance evaluation system, according to an example embodiment.

FIG. 3 is an illustration of frequency distributions which may be computed according to an example embodiment.

FIG. 4 is a simplified flow diagram for determining machine learning model performance metrics, according to an example embodiment.

FIG. 5 illustrates an example architecture for performance determination service that includes one or more service provider computers, a user device, and one or more facility computers in accordance with at least one embodiment.

### DETAILED DESCRIPTION

The present disclosure relates to evaluating the performance of trained machine learning models. More specifically, techniques are disclosed that improve the efficiency of evaluating machine learning models (e.g., due to faster processing capabilities).

In certain embodiments, a machine learning model may have been trained to perform a certain task. The training may have been carried out using a first set of data. The trained machine learning model may then be used in a runtime environment to generate predictions given runtime input data. The runtime input data may have different characteristics than the first set of data used to train the machine learning model. Thus, embodiments allow for the performance of model predictions to be evaluated.

In certain embodiments, a large dataset that includes model inference requests, responses, and ground truths can be used to determine the performance of the machine learning model (e.g., accuracy, precision). The large dataset may be too large to fit into memory (e.g., random access memory (RAM)) and therefore only a portion of the large dataset may be capable of fitting within memory. Embodiments may allow for the large dataset to be partitioned into a set of two or more partitions where intermediate computation is performed on each partition. Each partition may then be merged. The merged partition may then be used to produce a final metric value. The final metric value may be within certain error bounds. Further, in certain embodiments, the final metric value can be produced without assumptions and with only performing one pass over the large dataset.

Partitioning, performing intermediate computation, and merging data may allow for the trained model performance to be evaluated in a distributed manner and/or in a parallel manner. Further, partitioning, performing intermediate computation, and merging data may use less memory, computations, and time at any one machine that is used in the evaluation process compared to more conventional techniques. Further, techniques may reduce the amount of memory necessary by a machine that is used to compute performance metrics for machine learning models. Since some of the techniques can be implemented in a distributed environment, they may allow for increased scalability, allow for large amounts of data to be evaluated, and may be capable of optimizing network usage.

There are currently several problems relating to evaluating the performance of machine learning models. First, evaluating the performance of machine learning models may require large amount of data that is unable to fit within memory of a machine that is being used perform the evaluation of the machine learning model. Second, the large amount of data may need to be transmitted over a network before being then being run through an evaluation process which thereby increased network congestion. Among other problems, current solutions may also require that execution engines be used to compute performance metrics of machine learning models.

The present disclosure describes techniques for solving the above-mentioned problems.

The foregoing, together with other features and embodiments will become more apparent upon referring to the following specification, claims, and accompanying drawings.

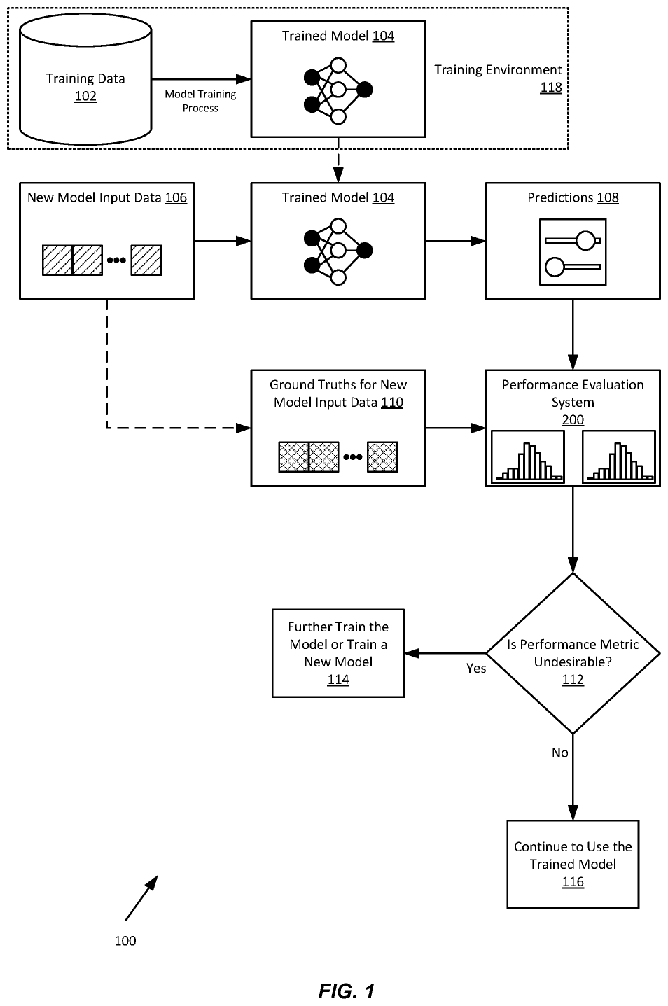

FIG. 1 is a simplified flow diagram 100 of how a performance evaluation system 200 can be used with a trained machine learning model (trained model 104), according to an example embodiment.

Flow diagram 100 illustrates that training data 102 may be used to perform a machine learning model training process (e.g., supervised, semi-supervised, unsupervised, reinforcement learning). The machine learning model training process may result in a trained model being produced. The trained model may be trained to perform a particular task (e.g., a classification task) in a training environment 118. The machine learning model may be considered a trained model once the model training process has achieved a sufficient performance threshold (e.g., accuracy value, precision value, recall value, specificity, and/or F1 score, etc.).

Flow diagram 100 further illustrates that the trained model 104 may then be used in a runtime environment where new model input data 106 is used with the trained model 104. For example, after a model is trained with a first set of data, the trained model 104 may be deployed for use. The deployed trained model 104 may receive input data that it has been trained with or that it has not been trained with. In certain cases, the trained model 104 may receive new model input data 106 that is different than the data it was trained with. For example, the input data may have a different format, have a different language, include different underlying patterns, or include any other different attribute. The input data (e.g., new model input data 106) may be used by the trained model 104 to generate predictions 108. The predictions 108 may be generated based on the trained model 104 and the new model input data 106. Thus, if characteristics of the new model input data 106 are sufficiently different from the training data 102, the trained model 104 may not generate predictions 108 in accordance with similar performance metrics obtained by the trained model 104 with the training data 102.

Accordingly, techniques described herein may be capable of evaluating the performance of the trained model 104. Techniques described herein may use the new model input data 106, the respective ground truths for the new model input data 110, and the respective predictions 108 generated by the trained model 104 from the respective new model input data 106 to evaluate the performance of the trained model 104. The performance of the trained model 104 may be evaluated using the performance evaluation system 200.

The performance evaluation system 200 may be capable of determining performance metrics of the trained model 104. The performance metrics determined by the performance evaluation system 200 may at least be: a true positive count (TP), a false positive count (FP), a false negative count (FN), a true negative count (TN), a true positive rate, or a false positive rate, ROC curve, and PR curve. Further, the performance metrics may also include metrics able to be determined by using the true positive count, the false positive count, the false negative count, the true negative count, the true positive rate, the false positive rate, the ROC curve, and/or the PR curve. For example, performance metrics may also include an accuracy, a precision, a recall, an F1 score, a specificity, etc.

The performance metrics may then be used for various purposes. The performance metrics may be used to generate model performance reports. The performance metrics may be used to determine if a model should be further trained or retrained. The performance metrics may also be used to determine if a new type of model should be used, if different training data should be used, if more training data should be used, etc.

For example, if one or more performance metrics fall below a threshold value, the performance metric may be determined to be undesirable at 112. Determining that a performance metric is undesirable at 112 may then result in an action being taken. For example, upon a performance metric of the trained model 104 being determined to be undesirable at 112, a new trained model may be generated using different data or other data in addition to the training data 102 that produced the trained model 104 to generate a new trained model at 114. In an example, a desired accuracy of the trained model 104 is 90% and the accuracy determined by the performance evaluation system 200 was 85%. In such an example, a new model may be trained (e.g., with different hyperparameters, with different data, with additional data, a different type of model, etc.) or the model may be further trained (e.g., using additional data) at 114.

In embodiments where the performance metric is not undesirable, the trained model 104 may continue to be used (e.g., in a runtime environment, may be further distributed, etc.) at 116.

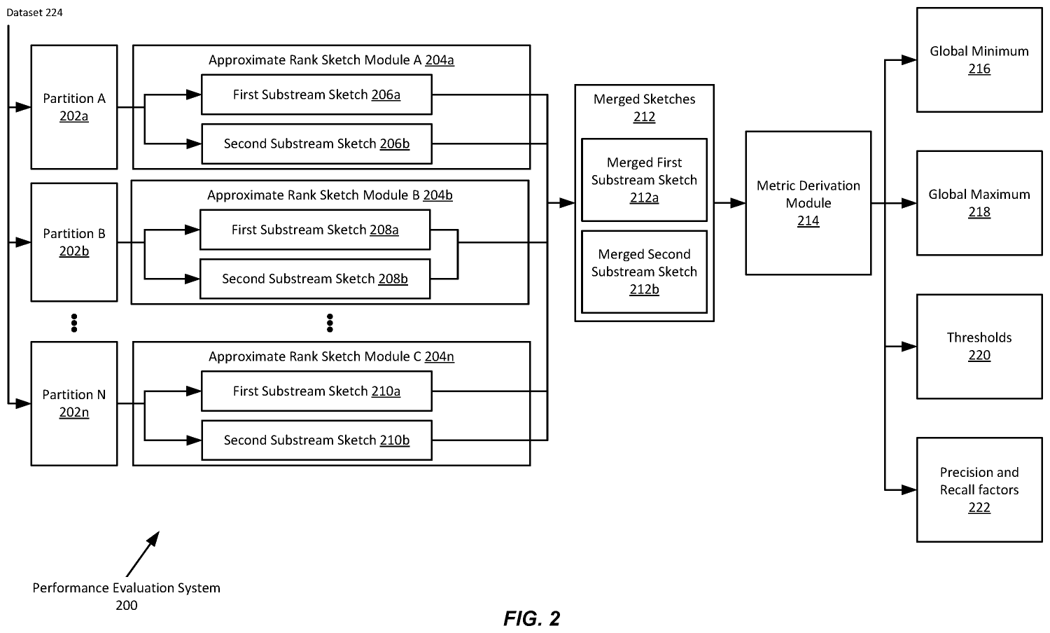

FIG. 2 is a simplified block diagram of a performance evaluation system 200, according to an example embodiment.

The performance evaluation system 200 may be the performance evaluation system 200 from flow diagram 100. The performance evaluation system 200 may receive a dataset 224. The performance evaluation system 200 may partition the dataset 224 into a number of partitions 202, perform intermediate computations on each partition 202, merge the results of the intermediate computations performed on each partition 202, and produce performance metric values using the merged values.

The performance evaluation system 200 may receive an input dataset 224. The dataset 224 may include ground truth values and prediction score values (e.g., confidence scores). The dataset 224 may include one or more elements.

In an embodiment, the ground truth values may be numerical values. The ground truth values may correspond to possible model outputs. For example, a binary classification model may be capable of classifying input data as one of two types of data. Thus, the ground truth values may be 0 or 1 in a binary classification scheme. The ground truth values may be obtained from a data source that includes the ground truth values that correspond to inputs. The inputs may be used by the trained model to produce output. The output may include prediction score values and a prediction.

In an embodiment, the prediction score values may be numerical values. For example, the prediction score values may be values between 0 and 1 and represent how confident the trained model was in making a corresponding generated prediction. Each ground truth may have a corresponding prediction score. The prediction score values may be output by the trained model as part of a generated prediction.

An example of an element in the dataset 224 is (ground truth value=1, prediction score=0.659285). The example element may represent that the trained model received input, the input causing the trained model to predict that the input is classified to be included in the 1 class with a confidence score of 0.659285, and the ground truth is 1. As a second example of an element in a dataset 224, the element is (ground truth value=0, prediction score=0.594275). The second example may be representative that the trained model has determined with a 0.594275 certainty that the classification for the input is a 0, and the ground truth is 0.

Each pair of ground truths and corresponding prediction scores may be considered to be an element in the dataset 224. The number of elements in the dataset 224 may be large. In certain embodiments, the memory required to store the dataset 224 (e.g., 50 GB) is larger than the amount of memory (e.g., RAM) available to a system (e.g., 32 GB). The dataset 224 may be divided into one or more partitions 202 in certain embodiments (represented by partition A 202a, partition B 202b, through partition N 202n).

In certain embodiments, the dataset 224 may be divided into a number of partitions 202 based on the amount of memory available compared to the amount of memory required to store the dataset 224. For example, a 50 GB dataset 224 may be partitioned into two or more partitions 202 if the memory available to compute performance metrics is less than 50 GB.

The dataset 224 may be divided into a number of partitions 202 based on network usage (e.g., bandwidth, memory, processing). For example, a certain portion of a network may have high network activity and therefore, more or less partitions 202 may be created to reduce the amount of packets (e.g., including ground truth data, prediction score values, and/or model output information, etc.) that are sent across a network segment. In another example, a certain system of a network may not have many available resources to compute intermediate computations, and therefore, not perform intermediate computations on a data partition 202.

In an example system A, system B, and system C are available to compute intermediate computations on data of a partition 202. System B may be experiencing high computational loads and system A and C may be capable of their available memory to generate sketches, thus system B may not be used and partitions 202 may be created for system A and system C.

In another example, the network traffic in the portion of the network that system B is located in has high network traffic activity and therefore system A and C are used if they are capable of generating substream sketches using only their available memory and partitions 202 are created accordingly. In yet another example, system A, system B, and system C are all used to reduce the computations performed by each system in creating the substream sketches and/or reduce the network activity of the portion of the network that the system is located within, and partitions are created accordingly 202.

The dataset 224 may be divided into a number of partitions 202 based on where the data is located and/or how much data is located at each respective location. For example, the output of the trained model and/or the ground truth data may be stored on multiple systems. Thus, the number of partitions 202 and the location of the partitions 202 may be determined based on where the data is located and/or how much data is located at each respective location. Such embodiments may be capable of reducing the load on a network, the load on a portion of a network, the memory usage of a specific machine, and/or the computational load on the specific machine.

The ground truth values may be received from a system that provides ground truths for corresponding model input data. Further, the prediction score values may be obtained as output from a trained model. The trained model may have generated the output based on using input data that corresponds to the ground truths for the corresponding model input data.

Elements of the dataset 224 received by the performance evaluation system 200 may be placed into a partition according to any of the above ways, at random, or in any other order.

In certain embodiments, the dataset 224 received by the performance evaluation system 200 is a data stream. A data stream may be a stream of data that is continuously received. A stream of data may be data that is generated over a period of time (e.g., 1 minute, 10 minutes, 1 hour, 1 day, 1 month). In certain embodiments, each partition 202 is generated from a separate data stream. In certain embodiments, each partition 202 is generated from a portion of a single data stream. In certain embodiments, the dataset 224 received by the performance evaluation system 200 is received from memory of one or more systems. In certain embodiments, each partition 202 may include a portion of the dataset 224 received from memory of one or more systems.

In certain embodiments, the same system performs calculations on each partition 202. For example, a first system may use a first partition (e.g., 202a) to generate a first primary substream sketch and a first secondary substream sketch before loading a second partition (e.g., 202b) into memory and generating a second primary substream sketch and a second secondary substream sketch and merging the first secondary substream sketch with the second secondary substream sketch and the first primary substream sketch with the second primary substream sketch.

The performance evaluation system 200 may also include one or more approximate rank sketch modules 204a (illustrated by approximate rank sketch module A 204a, approximate rank sketch module B 204b, through approximate rank sketch module N 204n). An approximate rank sketch module 204 may be capable of splitting partition 202 data into sub-stream sketches (e.g., a first substream sketch 206a and a second substream sketch 206b).

The substream sketches may be implemented using a quantile sketch, such as a KLL sketch or a REQ sketch. Substream sketches may be used as a data structure to store prediction score values. Using a substream sketch, a system may be capable of obtaining prediction score values, a size of the substream sketch, a minimum of the substream sketch, a maximum of the substream sketch, a frequency distribution, a rank of a value (e.g., prediction score value) at a specific threshold, and/or being merged with other substreams. The substreams are capable of performing these operations and being merged into a merged substream in sublinear space and may produce results within certain error bounds. The substream sketch may be capable of receiving a stream of data. A sketch capable of producing a rank of a value at a threshold or frequency distribution of the prediction score values (e.g., in the dataset) may be used as the substream sketch. A sketch capable of producing a minimum, maximum, and/or size of the prediction score values may be used as the substream sketch.

The space usage for the substreams sketch may be=O(K log N) where K=hyperparameter of the substream sketch and which may affect accuracy and where N=the total stream length. The error±ε of a rank r using a substream sketch may be represented as r≤εn and

$$K = O ( ( \frac{1}{ε} log ( ε ) )$$

Each partition 202 may be split into the substreams sketches based on the ground truth values of each element within the partition 202 data. Thus, the number of substream sketches generated based on partition 202 data may correspond to the number of unique ground truth values in the partition 202. In certain embodiments, the number of substream sketches generated is based on a predetermined number of substream sketches to be generated. In certain embodiments, two substream sketches for each partition.

In an example where data that has been binary classified, the partitioned data from partition A 202a may be split into one of two substreams of data (e.g., depending on the unique ground truth values included in elements of partition A 202a). In the example, partitioned data with a ground truth value of 1 may be placed into a first substream sketch 206a and partitioned data with a ground truth value of 0 may be placed into a second substream sketch 206b. Partitioned data from other partitions 202 may also be split into one of two substreams of data based on unique ground truth values included in the respective partition.

The first substream sketch 206a may be a first quantile sketch data structure and may be referred to as a positive substream sketch. The first quantile sketch data structure may be initialized before elements of the partition A 202a are received and added to the first quantile sketch.

The second substream sketch 206b may be a second quantile sketch data structure and may be referred to as a negative substream sketch. The second quantile sketch data structure may be initialized before elements from the partition A 202a are received and added to the second quantile sketch.

An element, or portion thereof (e.g., the prediction score of the element) from the partition 202 (e.g., partition B 202b) may be added to a substream sketch (e.g., a first substream sketch 208a or a second substream sketch 208b) by performing an update operation on the substream sketch with the element, or portion thereof. Through such a process, each element in a data partition 202 can be added to a substream sketch (e.g., a first substream sketch 208a or a second substream sketch 208b), resulting in a respective substream sketch (e.g., a first substream sketch 208a, a second substream sketch 208b) for each unique ground truth value in each data partition 202 (e.g., partition B 202b).

In embodiments with only a single partition 202 (e.g., a dataset that was not split among two or more partitions) and two unique ground truth values (e.g., binary classifier ground truths), the respective first substream sketch and the respective second substream sketch generated by the approximate rank sketch module are also considered a merged first substream sketch and merged second substream sketch since two or more first substream sketches and/or two or more second substream sketches do not need to be combined to generate a merged first substream sketch and/or merged second substream sketch.

In embodiments with two or more partitions (e.g., partition A 202a and partition B 202b), the substream sketches from each partition (e.g., first substream sketch 206a, second substream sketch 206b, first substream sketch 208a, and second substream sketch 208b) may be combined with substream sketches from one or more other partitions with a substream sketch that was generated using the same ground truth value. For example, first substream sketch 206a generated based on a ground truth value of one and elements included in partition A 202a may be merged with first substream sketch 208a generated based on the ground truth value of one and elements included in partition B 202b.

Two or more substream sketches (e.g., first substream sketch 206a and first substream sketch 208a) may be merged by performing a union operation. In certain embodiments, the union operation causes the unique elements between substreams sketches to be included into a merged substream sketch (e.g., merged first substream sketch 212a). In certain embodiments, the first substream sketch of a partition (e.g., first substream sketch 206a from partition A 202a) are merged with one or more other first substream sketches from one or more other partitions (e.g., first substream sketch 208a of partition B 202b and/or first substream sketch 210a from partition N 202n) to generate a merged first substream sketch 212a and the second substream sketch (e.g., second substream sketch 206b) may be merged with one or more other second substream sketches from one or more other partitions (e.g., second substream sketch 208b of partition B 202b and/or second substream sketch 210b from partition N 202n) to generate a merged second substream sketch (e.g., merged second substream sketch 212b).

A metric derivation module 214 may perform calculations using both of the merged first substream sketch 212a and the merged second substream sketch 212b. The metric derivation module 214 may perform various calculations. The calculations may result in performance metrics or result in values that can further be used to derive performance metrics. Some values that may be derived from the metric derivation module 214 are a global minimum 216, a global maximum 218, thresholds 220, and precision and recall factors 222.

The global minimum 216 that may be derived by the metric derivation module 214 may be a minimum of all the prediction score values capable of being obtained from each of the merged substream sketches. For example, the merged first substream sketch 212a and the merged second substreams sketch 212b. In certain embodiments, a minimum prediction score value may be obtained for each merged substream sketch (e.g., the merged first substream sketch 212a and the merged second substream sketch 212b), and the minimum prediction score value of each substream may be compared with all other substream sketch minimums to determine a global minimum 216.

In a similar fashion to the global minimum 216, the global maximum 218 may be derived by the metric derivation module 214 may be a maximum of all the prediction score values capable of being obtained from each of the merged substream sketches. For example, the merged first substream sketch 212a and the merged second substreams sketch 212b. In certain embodiments, a maximum prediction score value may be obtained for each merged substream sketch (e.g., the merged first substream sketch 212a and the merged second substream sketch 212b), and the maximum prediction score value of each substream may be compared with all other substreams maximums to determine a global maximum 218.

The thresholds 220 may be determined using the global minimum 216 value and the global maximum 218 value. Binning may be performed using the global minimum 216 value and the global maximum 218 value. In certain embodiments, the binning performed may generate N number of equidistant points between the global minimum 216 value and the global maximum 218 value. In certain embodiments, N is equal to the number of partitions 202 that were used in generating the merged substream sketches. In certain embodiments, N is equal to a predetermined number and may not be dependent on the number of partitions 202 and/or the number of substream sketches that were merged. The result of the binning that may be performed, may result in N thresholds 220 being produced. The N thresholds 220 may be values (e.g., N values) in a set. The values included in the thresholds 220 set may include the global minimum 216, the global maximum 218, and a number of values between the global minimum 216 and the global maximum 218 (e.g., N−2 values between the global minimum 216 and the global maximum 218). In certain embodiments, binning is performed to obtain an equal width of values. In certain embodiments, binning is performed to obtain an equal frequency of values. The binning may be used to obtain an underlying frequency distribution. Binning may be capable of reducing the effects of minor observation errors.

Since a substream (e.g., a merged substream) may be used to determine a global minimum 216 value and global maximum 218 value among one or more substreams, and binning may be performed, the contents of a substream may be represented as a frequency distribution and/or may be used to derive a frequency distribution.

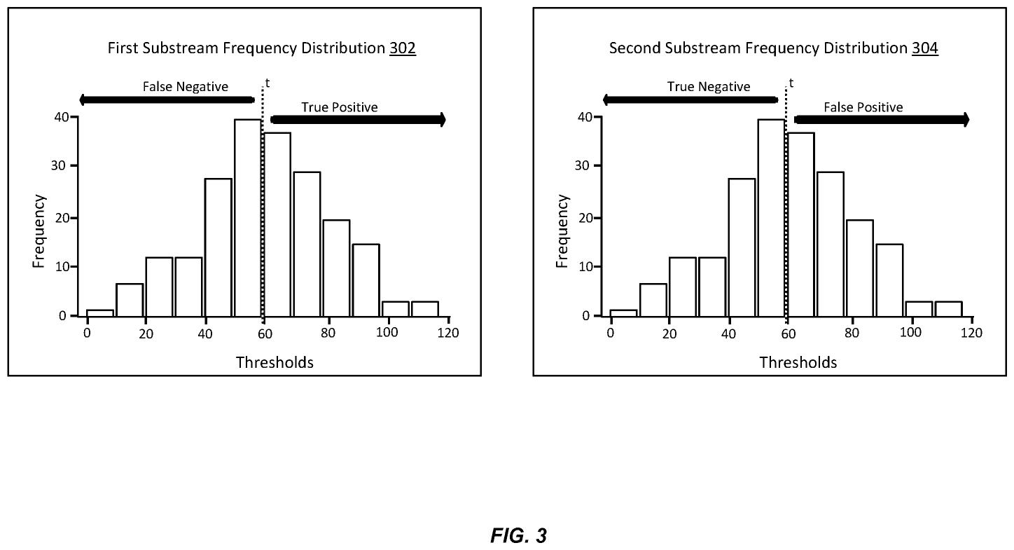

Briefly, jumping to FIG. 3. FIG. 3 is an illustration of frequency distributions which may be computed according to an example embodiment.

FIG. 3 illustrates a first substream frequency distribution 302. Additionally, FIG. 3 illustrates a second substream frequency distribution 304.

The frequency distribution may be capable of showing the frequency of different thresholds. Further, the first substream frequency distribution 302 may be used to compute the true positive and false negative count. Furthermore, the second substream frequency distribution 304 can be used compute a true negative and false positive count. The first substream may have been generated using one or more substream sketches based on a first ground truth value (e.g., 1). The second substream may have been generated using one or more substream sketches based on a second ground truth value (e.g., 0).

Returning to FIG. 2, a true positive count value can be determined using the first substream (e.g., the merged first substream 212a), the thresholds 220, and using a cumulative distribution function. The cumulative distribution function may be used to derive the probability that a random variable is less than or equal to a value within the thresholds 220. The result of the cumulative distribution function that uses the frequency distribution derivable from the first substream sketch (e.g., merged first substream sketch 212a) and the thresholds 220 (derived as discussed above) may be capable of producing a true positive count value.

In a similar fashion as the true positive count value, a false positive count value may be determined using a second substream (e.g., the merged second substream sketch 212b), the thresholds 220, and a cumulative distribution function. The result of the cumulative distribution function that uses the frequency distribution derivable from the second substream sketch (e.g., merged second substream sketch 212b) and the thresholds 220 (derived as discussed above) may be capable of producing a false positive count value.

A false negative count value may be derived by summing the total positive count and subtracting the true positive count value. Further, a true negative may be derived by summing the total negative count value and subtracting the false positive count value.

As one of ordinary skill in the art with the benefit of the present disclosure would realize, a true positive rate (TPR) may be determined by calculating (TP/(TP+FN)) and a false positive rate (FPR) may be determined by calculating (FP/(FP+TN)).

One of ordinary skill in the art would also recognize with the benefit of the present disclosure that an Receiver Operating Characteristic (ROC) and/or Precision Recall) PR curve may also be calculated using the values determined using the above techniques. Other performance metrics derivable using any of the values disclosed herein are also capable of being derived as a result of the above techniques.

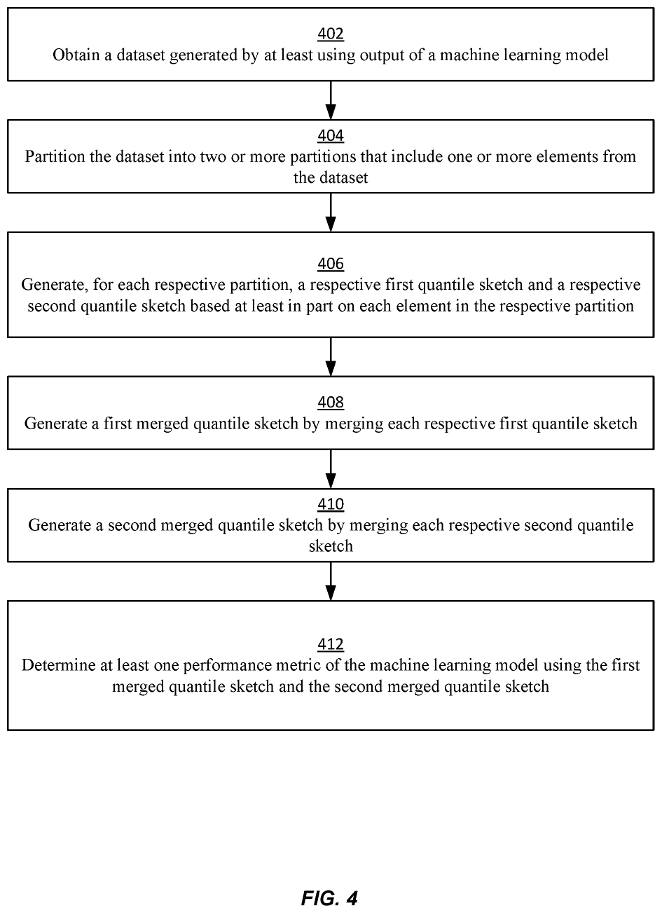

FIG. 4 is a simplified flow diagram for determining machine learning model performance metrics, according to an example embodiment.

At 402, a dataset may be obtained. The dataset may be obtained from another system and/or from memory. The dataset may have been generated using output of a machine learning model. The dataset may include output from a machine learning model (e.g., prediction score values) and/or predictions 108. The dataset may include ground truth values. The dataset may include values that have been output from one or more machine learning models. The dataset may include values that have been obtained over a period of time. The dataset may be a predetermined size (e.g., 50 GB) or may be a dynamic size based on the amount of time data was obtained for (e.g., data obtained over a period of 1 day).

At 404, the obtained dataset may be partitioned into two or more partitions that include one or more elements from the dataset. In certain embodiments, the dataset is not partitioned (e.g., there is a single data partition). The number of partitions may be based on available resources of a system (e.g., 4 computers available to assist in intermediate computations), available resources of components of the system (e.g., 4 computers in the system, but only 2 computers have the resources available to assist in intermediate computations), the amount of memory used by the dataset, the one or more locations (e.g., physical or network location) where the dataset is stored, and/or where performance metrics determined at 412 will be transmitted to, etc.

At 406, for each partition used for the dataset from 404, a one or more respective substream sketches (e.g., quantile sketches) may be generated. The number of quantile sketches that may be generated may be at least one and may be limited by the number of unique ground truth values in the respective partition of the dataset. In certain embodiments, when the respective partition of the dataset and/or the dataset has two unique ground truth values (e.g., 0 and 1), the respective partition may generate a respective first substream sketch (e.g., quantile sketch) and a second respective second substream sketch (e.g., quantile sketch). In certain embodiments, when the respective partition of the dataset and/or the dataset has two possible ground truth values (e.g., 0 and 1), the respective partition may generate a respective first substream sketch (e.g., quantile sketch) and a second respective second substream sketch (e.g., quantile sketch). Elements from the dataset partition may be added to a substream sketch based on the ground truth value of the element. For example, all elements of the dataset partition that have a ground truth value of 1 may be added to the first respective substream and all elements of the dataset partition that have a ground truth value of 0 may be added to the second respective substream. Adding elements to a substream may comprise performing an update operation on the substream. The update operation may add at least one of the portions of the element (e.g., the prediction score value of the element) to the substream.

At 408, a first respective substream sketch of a first partition may be merged with the first respective substream sketches of any other partition(s) to generate a first merged substream. The merging of substreams may be performed using a union operation. The union operation may cause all unique values of each substream to be added to a merged substream.

At 410, a second respective substream sketch of a first partition may be merged with the second respective substream sketches of any other partition(s) to generate a second merged substream.

In certain embodiments where there is only a single partition (e.g., the partition is the dataset), no merging may take place.

In certain embodiments, there may be more than the first and the second respective substreams to merge. In such embodiments, each respective substream generated from the respective partitions may be merged with one or more other respective substreams generated from the respective partitions. For example, all substream sketches among all partitions that were generated based on a ground truth value of an element being equal to 1 may be merged together.

As an example, if the dataset obtained at 402 included two unique ground truth values, no matter how many partitions were created from the dataset, two merged substreams would be generated at 408 and 409 using the respective substreams (e.g., merging substreams, if two or more substreams corresponding to the same ground truth) of the partitions.

At 412, at least one performance metric of the machine learning model may be determined. The at least one performance metric may be determined using both of the merged substream sketches. Each merged substream sketch may have been generated using one or more substream sketches. Each merged substream sketch may have been generated by merging (e.g., with a union operation) two or more substreams. The performance metrics capable of being determined using both of the merged substream sketches are a global minimum value of the prediction scores of the dataset, a global maximum value of the prediction scores of the dataset, thresholds and precisions recall factors.

The thresholds may include a number of equidistance points between the global minimum and the global maximum. The number of equidistance points may be equal to the number of partitions that were created from the dataset. The number of equidistance points may be a predetermined number and may be independent of the number of partitions that were created from the dataset.

The precisions recall factors may be a true positive, a false positive, a false negative, a true negative, a true positive rate (or a “recall”), a false positive rate, a precision, specificity, F1 score, accuracy, a PR curve, and/or an ROC curve, etc.

The described techniques may allow for as little as one pass to be performed over the dataset to obtain the precision recall factors. Further, the precision recall factors may be determined in a parallel and/or distributed manner.

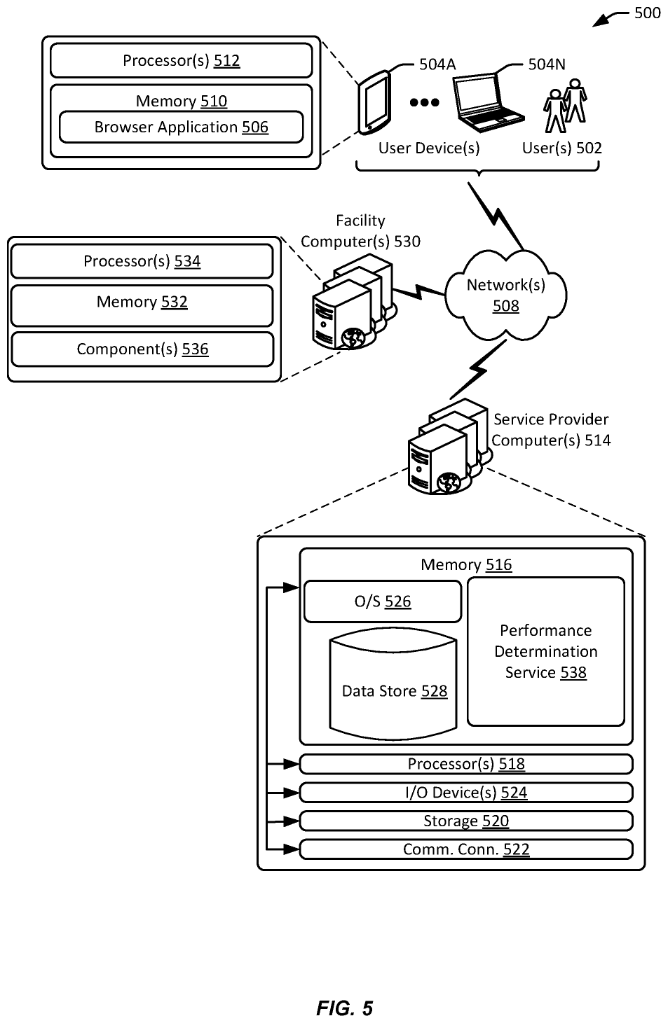

FIG. 5 illustrates an example architecture for an incremental snapshot service that includes one or more service provider computers, a user device, and one or more facility computers in accordance with at least one embodiment.

In the architecture 500, one or more users 502 who desire to create a snapshot may utilize user computing devices 504A-N (collectively, user devices 504) to access a browser application 506 or a user interface (UI) that can be accessed through the browser application 506 and via one or more networks 508, to receive text data, image data, video data, or the like, which may be presented and interacted with via browser application 506 or the UI accessible through the browser application 506. The “browser application” 506 can be or include any browser control or native application that can access and/or display a network page or other information. A native application may include an application or program that has been developed for use on a particular platform, such as an operating system, or a particular device such as a particular type of mobile device.

In accordance with at least one embodiment, the user devices 504 may be configured for communicating with service provider computers 514 and facility computers 530 via networks 508. The user devices 504 may include at least one memory, such as memory 510, and one or more processing units or one or more processors 512. The memory 510 may store program instructions that are loadable and executable on the one or more processors 512, as well as data generated during the execution of these programs. Depending on the configuration and type of the user devices 504, the memory 510 may be volatile, such as random access memory (RAM), and/or non-volatile such as read-only memory (ROM), flash memory, etc. The user devices 504 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program services, and other data for the user devices 504. In some implementations, the memory 510 may include multiple different types of memory, such as static random access memory (SRAM), dynamic random access memory (DRAM), ROM, etc.

Turning to the contents of the memory 510 in more detail, the memory 510 may include an operating system and one or more application programs or services for implementing the features disclosed herein. Additionally or alternatively, the memory 510 may include one or more services for implementing the features described herein such as an performance determination service 538 capable of being used for the techniques described with reference to FIGS. 1-4.

The architecture 500 may additionally include one or more service provider computers 514 that may, in some examples, provide computing resources such as, but not limited to, client entities, low latency data storage, durable data storage, data access, management, virtualization, hosted computing environment or “cloud-based” solutions, etc. The service provider computers 514 may implement or be an example of one or more incremental snapshot processes, block volume restore processes, or one or more service provider computers (e.g., the computing devices) described herein with reference to FIGS. 1-4 and/or throughout the disclosure. The one or more service provider computers 514 may also be operable to provide site hosting, computer application development, and/or implementation platforms, combinations of the foregoing, or the like to the one or more users 502 via user devices 504.

In some examples, the networks 508 may include any one or a combination of many different types of networks, such as cable networks, the Internet, wireless networks, cellular networks, and other private and/or public networks. While the illustrated examples represent the users 502 communicating with the service provider computers 514 over the networks 508, the described techniques may equally apply in instances where the users 502 interact with the one or more service provider computers 514 via the one or more user devices 504 over a landline phone, via a kiosk, or in any other manner. It is also noted that the described techniques may apply in other client/server arrangements, such as set-top boxes, etc., as well as in non-client/server arrangements such as locally stored applications, peer-to-peer arrangements, etc. In embodiments, the users 502 may communicate with the facility computers 530 via networks 508, and the facility computers 530 may communicate with the service provider computers 514 via networks 508. In some embodiments, the service provider computers 514 may communicate, via networks 508, with one or more third party computers (not illustrated) to obtain data inputs for the various algorithms of the generation features described herein. In accordance with at least one embodiment, the service provider computers 514 may receive text data, video data, image data, one or more prompts, aggregated inputs generated from the foregoing, or the like for at least refining a prompt for a generative model.

The one or more service provider computers 514 may be or include any type of computing devices such as, but not limited to, a mobile phone, a smart phone, a personal digital assistant (PDA), a laptop computer, a desktop computer, a server computer, a thin-client device, a tablet PC, etc. Additionally, it should be noted that in some embodiments, the one or more service provider computers 514 may be executed by one or more virtual machines implemented in a hosted computing environment. The hosted computing environment may include one or more rapidly provisioned and released computing resources, which computing resources may include computing, networking, and/or storage devices. A hosted computing environment may also be referred to as a cloud computing environment or a distributed computing environment. In some examples, the one or more service provider computers 514 may be in communication with the user device 504 via the networks 508, or via other network connections. The one or more service provider computers 514 may include one or more servers, which may be arranged in a cluster or as individual servers not associated with one another. In embodiments, the service provider computers 514 may be in communication with one or more third party computers (not illustrated) via networks 508 to receive or to otherwise obtain data including text data, video data, image data, one or more prompts, aggregated inputs generated from the foregoing, or the like for at least refining a prompt for a generative model.

In one illustrative configuration, the one or more service provider computers 514 may include at least one memory, such as memory 516, and one or more processing units or one or more processors 518. The one or more processors 518 may be implemented as appropriate in hardware, computer-executable instructions, firmware, or any combination thereof. Computer-executable instruction or firmware implementations of the one or more processors 518 may include computer-executable or machine-executable instructions written in any suitable programming language to perform the various functions described when executed by a hardware computing device such as a processor. The memory 516 may store program instructions that are loadable and executable on the one or more processors 518, as well as data generated during the execution of these programs. Depending on the configuration and type of the one or more service provider computers 514, the memory 516 may be volatile, such as RAM, and/or non-volatile such as ROM, flash memory, etc. The one or more service provider computers 514 or servers may also include additional storage 520, which may include removable storage and/or non-removable storage. The additional storage 520 may include, but is not limited to, magnetic storage, optical disks and/or tape storage. The disk drives and their associated computer-readable media may provide non-volatile storage of computer-readable instructions, data structures, program services, and other data for the computing devices. In some implementations, the memory 516 may include multiple different types of memory, such as SRAM, DRAM, ROM, etc.

The memory 516, the additional storage 520, removable and/or non-removable, are examples of non-transitory computer-readable storage media. For example, computer-readable storage media may include volatile or non-volatile, removable or non-removable media implemented in any method or technology for storage of information such as computer-readable instructions, data structures, program services, or other data. The memory 516 and the additional storage 520 are examples of non-transitory computer storage media. Additional types of non-transitory computer storage media that may be present in the one or more service provider computers 514 may include, but are not limited to, PRAM, SRAM, DRAM, RAM, ROM, EEPROM, flash memory or other memory technology, CD-ROM, DVD, or other optical storage, magnetic cassettes, magnetic tape, magnetic disk storage or other magnetic storage devices, or any other medium which can be used to store the desired information and which can be accessed by the one or more service provider computers 514. Combinations of any of the above should also be included within the scope of non-transitory computer-readable media.

The one or more service provider computers 514 may also include one or more communication connection interfaces 522 that can allow the one or more service provider computers 514 to communicate with a data store, another computing device or server, user terminals, and/or other devices on the networks 508. The one or more service provider computers 514 may also include one or more I/O devices 524, such as a keyboard, a mouse, a pen, a voice input device, a touch input device, a display, speakers, a printer, etc.

Turning to the contents of the memory 516 in more detail, the memory 516 may include an operating system 526, one or more data stores 528, and/or one or more application programs or services for implementing the features disclosed herein including the performance determination service 538. The architecture 500 includes facility computers 530. In embodiments, the service provider computers 514 and the performance determination service 538 may be configured to generate and transmit instructions, via networks 508, to components 536 in communication or otherwise associated with facility computers 530. For example, the instructions may be configured to create a first incremental block volume snapshot or restore a block volume using a second incremental block volume snapshot determined by the performance determination service 538. The facility computers 530 may include at least one memory, such as memory 532, and one or more processing units or one or more processors 534. The memory 532 may store program instructions, which may include one or more techniques as disclosed herein, that can be loaded and executed on the one or more processors 534, as well as data generated during the execution of these techniques. Depending on the configuration and type of the facility computers 530, the memory 532 may be volatile, such as random access memory (RAM), and/or non-volatile such as read-only memory (ROM), flash memory, etc. The facility computers 530 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program services, and other data for the facility computers 530. In some implementations, the memory 532 may include multiple different types of memory, such as static random access memory (SRAM), dynamic random access memory (DRAM), ROM, etc.

Turning to the contents of the memory 532 in more detail, the memory 532 may include an operating system and one or more application programs or services for implementing the features disclosed herein. Additionally, the memory 532 may include one or more services for implementing the features described herein, which may include the performance determination service 538. In some embodiments, the service provider computers 514 and the performance determination service 538 may determine one or more blocks of a block volume to generate a snapshot for. The user device 504 and the browser application 506 may be configured to transmit the output to the user 502. In accordance with at least one embodiment, the performance determination service 538 may be configured to receive manifests, snapshots, block volume data, and the like. In some embodiments, some, a portion, or all of these input data may be stored and transmitted as text files or other files, which may include text data. In some embodiments, the performance determination service 538 may be configured to implement one or more techniques for creating a restore block volume using at least one manifest and at least one snapshot.

The performance determination service 538 may be configured to generate and transmit a user interface or data objects for updating a user interface presented via browser application 506 and user device 504 for presenting information relating to a block volume, snapshot, manifest, or any components thereof or associated therewith to the user 502. Other graphical updates, feedback mechanisms, and data object generation associated with the incremental snapshot features described herein may be implemented by the service provider computers 514 and/or the performance determination service 538.

Any of the software components or functions described in this application, may be implemented as software code to be executed by a processor using any suitable computer language such as, for example, Java, C++, or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The figures and above description are illustrative and is not restrictive. In the above description, for the purposes of explanation, specific details are set forth in order to provide a thorough understanding of certain embodiments. However, it will be apparent that various embodiments may be practiced without these specific details. Many variations of the techniques described herein may become apparent to those skilled in the art upon review of the disclosure. The scope of the techniques can, therefore, be determined not with reference to the above description, but instead can be determined with reference to the pending claims along with their full scope or equivalents.

One or more features from any embodiment may be combined with one or more features of any other embodiment without departing from the scope of the techniques.

Due to the ever-changing nature of computers and networks, the description of architecture 500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method of determining at least one performance metric of a machine learning model, the method comprising:
obtaining a dataset generated by at least using output of the machine learning model;
partitioning the dataset into two or more partitions that include one or more elements from the dataset;
generating, for each respective partition, a respective first quantile sketch and a respective second quantile sketch based at least in part on each element in the respective partition;
generating a first merged quantile sketch by merging each respective first quantile sketch;
generating a second merged quantile sketch by merging each respective second quantile sketch; and
determining the at least one performance metric of the machine learning model using the first merged quantile sketch and the second merged quantile sketch.

2. The computer-implemented method of claim 1, wherein the dataset includes a prediction score value from the output of the machine learning model and a ground truth value.

3. The computer-implemented method of claim 1, wherein the partitioning occurs based on at least one of: a size of the dataset, available resources, location of the available resources, and network activity.

4. The computer-implemented method of claim 1, wherein the respective first quantile sketch is generated based on the elements included in the respective partition that include a first ground truth value.

5. The computer-implemented method of claim 1, wherein the at least one performance metric includes at least one of: a true positive value, a false positive value, a false negative value, a true negative value, a true positive rate (or a “recall”), a false positive rate, a precision value, specificity value, F1 score, an accuracy value, a PR curve, and an ROC curve.

6. The computer-implemented method of claim 1, wherein a number of merged quantile sketches is dependent on a number of unique ground truth values included in the dataset.

7. The computer-implemented method of claim 1, wherein merging each respective first quantile sketch further comprises:
performing a union operation using each respective first quantile sketch.

8. A non-transitory computer-readable storage medium storing a plurality of instructions executable by one or more processors of a system to determine at least one performance metric of a machine learning model, the plurality of instructions cause, when executed by the one or more processors of the system, the one or more processors to perform operations comprising:
obtaining a dataset generated by at least using output of the machine learning model;
partitioning the dataset into two or more partitions that include one or more elements from the dataset;
generating, for each respective partition, a respective first quantile sketch and a respective second quantile sketch based at least in part on each element in the respective partition;
generating a first merged quantile sketch by merging each respective first quantile sketch;
generating a second merged quantile sketch by merging each respective second quantile sketch; and
determining the at least one performance metric of the machine learning model using the first merged quantile sketch and the second merged quantile sketch.

9. The non-transitory computer-readable storage medium of claim 8, wherein the dataset includes a prediction score value from the output of the machine learning model and a ground truth value.

10. The non-transitory computer-readable storage medium of claim 8, wherein the partitioning occurs based on at least one of: a size of the dataset, available resources, location of the available resources, and network activity.

11. The non-transitory computer-readable storage medium of claim 8, wherein the respective first quantile sketch is generated based on the elements included in the respective partition that include a first ground truth value.

12. The non-transitory computer-readable storage medium of claim 8, wherein the at least one performance metric includes at least one of: a true positive value, a false positive value, a false negative value, a true negative value, a true positive rate (or a “recall”), a false positive rate, a precision value, specificity value, F1 score, an accuracy value, a PR curve, and an ROC curve.

13. The non-transitory computer-readable storage medium of claim 8, wherein a number of merged quantile sketches is dependent on a number of unique ground truth values included in the dataset.

14. The non-transitory computer-readable storage medium of claim 8, wherein merging each respective first quantile sketch further comprises:
performing a union operation using each respective first quantile sketch.

15. A system for determining at least one performance metric of a machine learning model, comprising:
one or more data processors; and
a computer-readable storage medium comprising instructions that, when executed on the one or more data processors, cause the one or more data processors to perform operations comprising:
obtaining a dataset generated by at least using output of the machine learning model;
partitioning the dataset into two or more partitions that include one or more elements from the dataset;
generating, for each respective partition, a respective first quantile sketch and a respective second quantile sketch based at least in part on each element in the respective partition;
generating a first merged quantile sketch by merging each respective first quantile sketch;
generating a second merged quantile sketch by merging each respective second quantile sketch; and
determining the at least one performance metric of the machine learning model using the first merged quantile sketch and the second merged quantile sketch.

16. The system of claim 15, wherein the dataset includes a prediction score value from the output of the machine learning model and a ground truth value.

17. The system of claim 15, wherein the partitioning occurs based on at least one of: a size of the dataset, available resources, location of the available resources, and network activity.

18. The system of claim 15, wherein the respective first quantile sketch is generated based on the elements included in the respective partition that include a first ground truth value.

19. The system of claim 15, wherein the at least one performance metric includes at least one of: a true positive value, a false positive value, a false negative value, a true negative value, a true positive rate (or a “recall”), a false positive rate, a precision value, specificity value, F1 score, an accuracy value, a PR curve, and an ROC curve.

20. The system of claim 15, wherein a number of merged quantile sketches is dependent on a number of unique ground truth values included in the dataset.
